(19) United States
(12) Patent Application Publication
(10) Pub. No.: US 2019/0160435 A1
(43) Pub. Date: May 30, 2019

(54) SEPARATION MEMBRANE ELEMENT

(71) Applicant: TORAY INDUSTRIES, INC., Tokyo (JP)

(72) Inventors: Hiroho HIROZAWA, Shiga (JP); Kentarou TAKAGI, Shiga (JP); Yoshiki OKAMOTO, Shiga (JP); Satoshi KATO, Shiga (JP); Takeshi KONDA, Shiga (JP); Hiroyuki YAMADA, Shiga (JP); Tamotsu KITADE, Shiga (JP); Akshay GARG, Shiga (JP)

(73) Assignee: TORAY INDUSTRIES, INC., Tokyo (JP)

(21) Appl. No.: 16/320,893

(22) PCT Filed: Jul. 26, 2017
(86) PCT No.: PCT/JP2017/026989

§ 371 Date: Jan. 25, 2019

(30) Foreign Application Priority Data
Jul. 28, 2016 (JP) 2016-148402
Sep. 8, 2016 (JP) 2016-175322
Apr. 28, 2017 (JP) 2017-089307

(51) Int. Cl. B01D 63/12; B01D 69/10

(52) U.S. Cl. CPC B01D 63/12; B01D 2313/146; B01D 2313/12; B01D 69/10

(57) ABSTRACT

The present invention relates to a separation membrane element for use in separation of ingredients contained in fluids such as liquid and gas. An object of the present invention is to provide a separation membrane element which, even when used in a high-recovery ratio operation, has high fresh-water production performance and high removal performance and is less apt to suffer scaling.

### TECHNICAL FIELD

The present invention relates to a separation membrane element for use in separation of ingredients contained in fluids such as liquid and gas.

### BACKGROUND ART

In the recent technique for removal of ionic substances contained in seawater, brackish water or the like, separation methods utilizing separation membrane elements have found increasing uses as processes for energy savings and conservation of resources. Separation membranes adopted in the separation methods utilizing separation membrane elements are classified into five groups according to their pore sizes and separation performance, namely microfiltration membranes, ultrafiltration membranes, nanofiltration membranes, reverse osmosis membranes and forward osmosis membranes. These membranes have been used, for example, in production of drinkable water from seawater, brackish water, water containing deleterious substances, or the like, production of ultrapure water for industrial uses, effluent treatment, recovery of valuable substances, or the like, and have been used properly according to ingredients targeted for separation and separation performance requirements.

Separation membrane elements have various shapes, but they are common in that they feed raw water to one surface of a separation membrane and obtain permeate from the other surface thereof. By having a plurality of separation membranes tied in a bundle, each separation membrane element is configured to extend the membrane area per separation membrane element, in other words, to increase the amount of permeate obtained per separation membrane element. Various types of shapes, such as a spiral type, a hollow fiber type, a plate-and-frame type, a rotating flat-membrane type and a flat-membrane integration type, have been proposed for separation membrane elements, according to their uses and purposes.

For example, spiral-type separation membrane elements have been widely used in reverse osmosis filtration. The spiral-type separation membrane element includes a central tube and a stack wound up around the central tube. The stack is formed by stacking a raw-water-side channel material for feeding raw water (that is, water to be treated) to a surface of a separation membrane, a separation membrane for separating ingredients contained in the raw water and a permeate-side channel material for leading into the central tube a permeate-side fluid having been separated from the raw-water-side fluid by passing through the separation membrane. In the spiral-type separation membrane element, it is possible to apply pressure to the raw water, and therefore, it has been preferably used so that a large amount of permeate can be taken out.

In the spiral-type separation membrane element, generally, a net made of a polymer is mainly used as the raw-water-side channel material in order to form a flow channel for the raw-water-side fluid. In addition, a multilayer-type separation membrane is used as the separation membrane. The multilayer-type separation membrane includes a separation functional layer formed of a crosslinked polymer such as polyamide, a porous resin layer (porous supporting layer) formed of a polymer such as polysulfone, and a nonwoven fabric substrate made of a polymer such as polyethylene terephthalate, which are stacked from a raw-water side to a permeate side. Also, as the permeate-side channel material, a knitted fabric member (also called weft knitted fabric) referred to as tricot, which is finer in mesh than the raw-water-side channel material, has been used for the purposes of preventing the separation membrane from sinking and of forming a permeate-side flow channel.

In recent years, from increased demands for reduction in cost of fresh water production, separation membrane elements having higher performance have been required. For example, in order to improve separation performance of the separation membrane elements and to increase the permeate amount per unit time, improvements in performance of separation membrane element members such as channel materials have been proposed.

Specifically, Patent Document 1 proposes a separation membrane element including a channel material obtained by disposing yarns on nonwoven fabric. Patent Document 2 proposes a separation membrane element for which a general-purpose film is imprinted to form dots or the like to improve the property of passing liquids in film-surface directions. Such a separation membrane element 5 is obtained, as shown in FIG. 1, by sandwiching a raw-water-side channel material 1 between separation membranes 2, superposing a permeate-side channel material 3 thereon to form one unit, and spirally winding the unit around a water collection tube 4.

Patent Document 3 proposes a separation membrane element having a configuration in which raw water is introduced through both width-direction ends of the element and discharged as a concentrate through a peripheral part. Patent Documents 4 and 5 propose separation membrane elements each having a configuration in which raw water is fed through a peripheral part of the element and discharged as a concentrate through one end of the element. These separation membrane elements each can be obtained, like the separation membrane element 5, by sandwiching a raw-water-side channel material 1 between separation membranes 2, superposing a permeate-side channel material 3 thereon to form one unit, and spirally winding the unit around a water collection tube 4. However, these separation membrane elements each differ from the separation membrane element 5 in that the raw-water inflow part or the concentrate discharge part lies in a peripheral part of the separation membrane element.

### BACKGROUND ART DOCUMENT

### Patent Document

Patent Document 1: US 2012/0261333
Patent Document 2: JP-A-2006-247453
Patent Document 3: US 2012/0117878
Patent Document 4: JP-A-11-188245
Patent Document 5: JP-A-5-208120

### SUMMARY OF THE INVENTION

### Problems that the Invention is to Solve

However, the separation membrane elements proposed in Patent Document 1 and Patent Document 2 have a configuration in which raw water flows from one end face to the other end face of the element and concentration polarization is hence prone to occur. Especially in the case where a high-recovery ratio operation (recovery ratio:proportion of the amount of produced fresh water to the amount of raw water fed to the element) is performed, there is a problem in that the fresh-water production performance and the removal performance are prone to decrease and scaling is prone to occur.

Meanwhile, in the configurations described in Patent Documents 3 to 5, the raw-water-side channel and the permeate-side channel have high flow resistance and it is necessary to shorten the channels to lower the resistance, resulting in a problem in that the raw-water-side channel is too short and the raw-water-side flow rate also is too low.

An object of the present invention is to provide a separation membrane element which, even when used in a high-recovery ratio operation, has high fresh-water production performance and high removal performance and is less apt to suffer scaling.

### Means for Solving the Problems

In order to achieve the above-described object, the present invention provides (1) a separation membrane element including:

a plurality of separation membranes each having a raw-water-side face and a permeate-side face and forming a separation membrane leaf by being arranged so that the raw-water-side faces face each other;

a permeate-side channel material provided between the permeate-side faces of the separation membranes to form a permeate-side channel;

a raw-water-side channel material provided between the raw-water-side faces of the separation membranes to form a raw-water-side channel; and

a water collection tube for collecting a permeate,

in which the separation membrane leaf has openings respectively in a peripheral part in a direction perpendicular to a longitudinal direction of the water collection tube, and in an end face in the longitudinal direction of the water collection tube, and

the separation membrane leaf has a width W1 of 150 mm to 400 mm,

the permeate-side channel material has a coefficient of variation in channel width of 0.00-0.10, and the separation membrane leaf has a ratio between the width W1 and a length L of the separation membrane leaf, L/W1, of 2.5 or larger.

According to a preferable embodiment of the present invention, (2) the separation membrane element according to (1), in which a length of the raw-water-side channel, namely the length L of the separation membrane leaf, is 750 mm to 2,000 mm, is provided.

According to a preferable embodiment of the present invention, (3) the separation membrane element according to (1) or (2), which includes:

a raw-water feed part which is the opening formed in the peripheral part of the separation membrane leaf in the direction perpendicular to the longitudinal direction of the water collection tube; and

a concentrate discharge part which is the opening formed in a one-side end face of the separation membrane leaf in the longitudinal direction of the water collection tube,

the concentrate discharge part being an opening formed by opening a part of the one-side end face, is provided.

According to a preferable embodiment of the present invention, (4) the separation membrane element according to (3), in which the concentrate discharge part has a length which is 5-35% of the length L of the separation membrane leaf, is provided.

According to a preferable embodiment of the present invention, (5) the separation membrane element according to (3), in which the concentrate discharge part has a length which is 15-25% of the length L of the separation membrane leaf, is provided.

According to a preferable embodiment of the present invention, (6) the separation membrane element according to (1) or (2), which includes:

a raw-water feed part which is the opening formed in a one-side end face of the separation membrane leaf in the longitudinal direction of the water collection tube; and

a concentrate discharge part which is the opening formed in the peripheral part of the separation membrane leaf in the direction perpendicular to the longitudinal direction of the water collection tube,

the concentrate discharge part being an opening formed by opening a part of the peripheral part, is provided.

According to a preferable embodiment of the present invention, (7) the separation membrane element according to (6), in which the raw-water feed part has a length which is 10-40% of the length L of the separation membrane leaf, is provided.

According to a preferable embodiment of the present invention, (8) the separation membrane element according to (6), in which the raw-water feed part has a length which is 15-20% of the length L of the separation membrane leaf, is provided.

According to a preferable embodiment of the present invention, (9) the separation membrane element according to (1) or (2), which includes:

raw-water feed parts which are the openings formed in both end faces of the separation membrane leaf in the longitudinal direction of the water collection tube; and

a concentrate discharge part formed in the peripheral part of the separation membrane leaf in the direction perpendicular to the longitudinal direction of the water collection tube,

the raw-water feed parts being openings formed by opening a part of each of the both end faces, is provided.

According to a preferable embodiment of the present invention, (10) the separation membrane element according to (9), in which the raw-water feed parts have a length which is 5-45% of the length L of the separation membrane leaf, is provided.

According to a preferable embodiment of the present invention, (11) the separation membrane element according to (9), in which the raw-water feed parts have a length which is 15-30% of the length L of the separation membrane leaf, is provided.

According to a preferable embodiment of the present invention, (12) the separation membrane element according to any one of (1) to (11), in which the opening of the end face in the longitudinal direction of the water collection tube is formed as a single opening extending from an inner end of the separation membrane leaf toward an outside along the direction perpendicular to the longitudinal direction of the water collection tube, is provided.

According to a preferable embodiment of the present invention, (13) a method for operating the separation membrane element according to any one of (1) to (12), in which water is fed to the separation membrane element to produce fresh water in an amount which is 35% or more of the water fed to the separation membrane element, is provided.

According to a preferable embodiment of the present invention, (14) a separation membrane element including:

a plurality of separation membranes each having a raw-water-side face and a permeate-side face and forming a separation membrane leaf by being arranged so that the raw-water-side faces face each other;

a permeate-side channel material provided between the permeate-side faces of the separation membranes to form a permeate-side channel; and

a water collection tube for collecting a permeate,

in which the permeate-side channel material has a cross-section along a longitudinal direction of the water collection tube, the cross-section having a plurality of channels and having a cross-section area ratio of 0.4-0.75, and

the separation membrane leaf includes: a raw-water feed part which is an opening formed in a peripheral part of the separation membrane leaf in a direction perpendicular to the longitudinal direction of the water collection tube; and

a concentrate discharge part which is an opening formed in an end-face side portion in the longitudinal direction of the water collection tube, is provided.

### Advantage of the Invention

According to the present invention, it is possible to obtain a separation membrane element which has such a configuration that raw water passes therethrough at an increased flow rate and is less apt to cause concentration polarization and which hence is less apt to suffer scaling especially in a high-recovery ratio operation and is excellent in terms of fresh-water production rate and removal performance.

### BRIEF DESCRIPTION OF THE DRAWINGS

FIG. 1 is a schematic view showing one example of general separation membrane elements.

FIG. 2 is a schematic view showing one example of an L-type separation membrane element according to the present invention.

FIG. 3 is an example of a cross-sectional view of a permeate-side channel material applicable to the present invention.

FIG. 4 is another example of a cross-sectional view of a permeate-side channel material applicable to the present invention.

FIG. 5 is a cross-sectional view which illustrates the configuration of a permeate-side channel material applicable to the present invention.

FIG. 6 shows one example of permeate-side channel materials applicable to the present invention.

FIG. 7 shows another example of the permeate-side channel materials applicable to the present invention.

FIG. 8 is a schematic view showing a flow of raw water in an L-type element according to the present invention.

FIG. 9 is a schematic view showing a flow of raw water in an inverted-L-type separation membrane element according to the present invention.

FIG. 10 is a schematic view showing a flow of raw water in an IL-type separation membrane element according to the present invention.

FIG. 11 is a schematic view showing a flow of raw water in a T-type separation membrane element according to the present invention.

FIG. 12 is a plan view which illustrates the configuration of a permeate-side channel material applicable to the present invention.

### MODE FOR CARRYING OUT THE INVENTION

Some embodiments of the separation membrane element of the present invention are described in detail below.

<Outline of Separation Membrane Element>

In the separation membrane element of the present invention, the separation membrane leaf, which is formed by separation membranes arranged so that the raw-water-side faces thereof face each other and which includes a raw-water feed part or a concentrate discharge part in a peripheral part in a direction (referred to also as winding direction) perpendicular to the longitudinal direction of the water collection tube, has a width W1 of 150 mm to 400 mm. This separation membrane element includes a permeation-side channel material having a coefficient of variation in channel width of 0.00-0.10. Because of this, the ratio between the width W1 of the separation membrane leaf and the length L of the separation membrane leaf, L/W1, can be increased to 2.5 or larger.

Usually, flow resistance increases in proportion to water amount and channel length. However, this configuration enables the separation membrane element to be reduced in the permeate-side flow resistance, making it possible to inhibit the permeate-side flow resistance from increasing even when the channel length is increased. Namely, the flow resistance can be inhibited from increasing even when the membrane leaf is elongated, i.e., the permeate-side channel is elongated. Consequently, the separation membrane element can have an elongated raw-water-side cannel and an increased raw-water flow rate and be less apt to suffer scaling.

<Permeate-Side Channel Material>

The separation membrane element of the present invention includes a permeate-side channel material disposed on the permeate side of a separation membrane. From the standpoints of reducing the flow resistance of the permeate-side channel and stably forming the channel even in pressure filtration, the permeate-side channel material is required to have a coefficient of variation in channel width in the winding direction of the permeate-side channel material (also referred to as “coefficient of variation in channel width”) of 0.00-0.10. The permeate-side channel material is not limited in the kind thereof so long as the channel material has a coefficient of variation in channel width within that range. Use can be made of a weft knitted fabric which is conventional tricot formed thickly so as to give a widened channel, a weft knitted fabric having a reduced fiber basis weight, or a rugged sheet obtained by disposing projections on a porous sheet such as a nonwoven fabric or by imparting ruggedness to a film or nonwoven fabric.

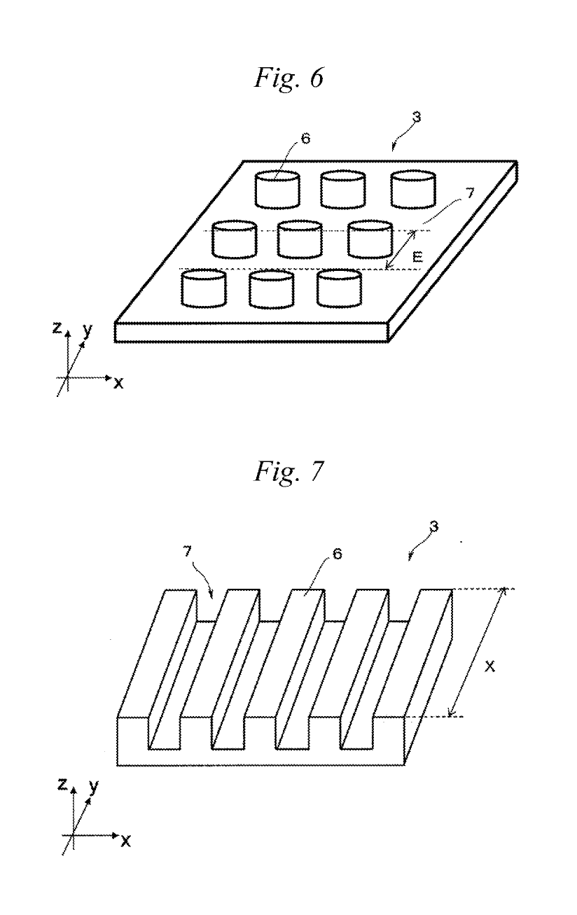

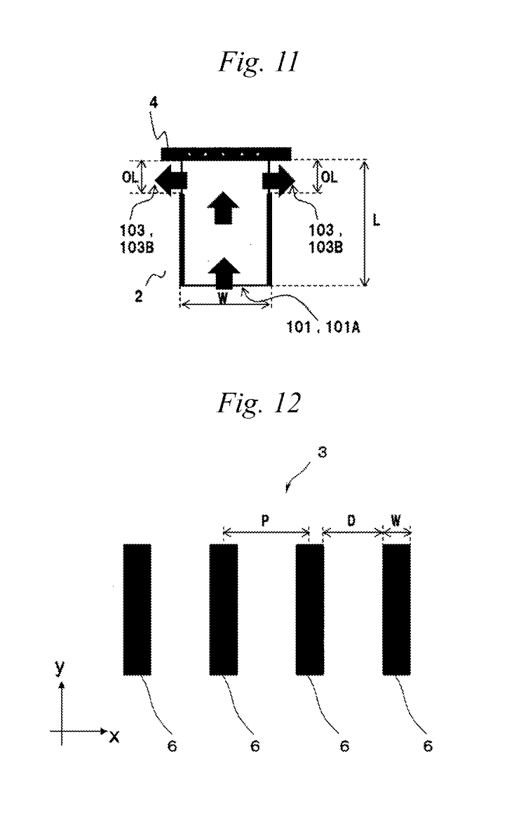

The coefficient of variation in channel width is explained here. FIG. 12 shows a plan view of a sheet-shaped permeate-side channel material, as an example, which is viewed from the rugged-face side. After the permeate-side channel material is fitted into a separation membrane element, the element is cut along the longitudinal direction of the water collection tube so that the protrusions of the permeate-side channel material are cut, thereby obtaining a sample. This sample is examined from over the protrusions. An average value of the width of a protrusion and the width of an adjacent protrusion is subtracted from the distance P (also referred to as pitch) between the center of the former protrusion and the center of the other protrusion, and the value thus obtained is a channel width D. With respect to the same channel, a hundred portions are examined for channel width at intervals of 0.25 mm along the winding direction, and the standard deviation thereof is divided by the average value thereof. The resultant value is the coefficient of variation in channel width of the one channel. Likewise, the same operation is repeated with respect to other fifty channels to calculate the coefficient of variation in channel width of each channel. These coefficients of variation are averaged. Thus, the coefficient of variation in channel width can be determined. In the case of a permeate-side channel material which has projections and in which the height of the projections and the channel height along the winding direction of the separation membrane element are equal to those along the width direction of the element, as in FIG. 6, the distance between the center of each projection and the center of a width-direction adjacent projection is taken as a pitch and the coefficient of variation in channel width can be calculated from the pitches and channel widths for a hundred portions. The pitches and the widths of protrusions can be measured using a commercial microscope or electron microscope.

By disposing the permeate-side channel material described above in the separation membrane element of the present invention, the flow resistance of the permeate-side channel can be reduced. Due to this, in cases when this separation membrane element is operated at the same recovery ratio as a separation membrane element including a channel material having high flow resistance, the raw water can flow at an increased rate to reduce concentration polarization. Especially in high-recovery ratio operations, a reduction in concentration polarization and scaling inhibition can be attained.

Although general separation membrane elements are operated at a recovery ratio of 30% or less, the separation membrane element of the present invention can be stably operated even at a recovery ratio of 35% or higher. The higher the recovery ratio, the more the separation membrane element of the invention can have an advantage over the conventional separation membrane elements.

<Cross-Section Area Ratio>

In cases when the permeate-side channel material has a cross-section area ratio of 0.4-0.75, a wide channel can be ensured and the flow resistance of the permeate-side channel can be efficiently reduced.

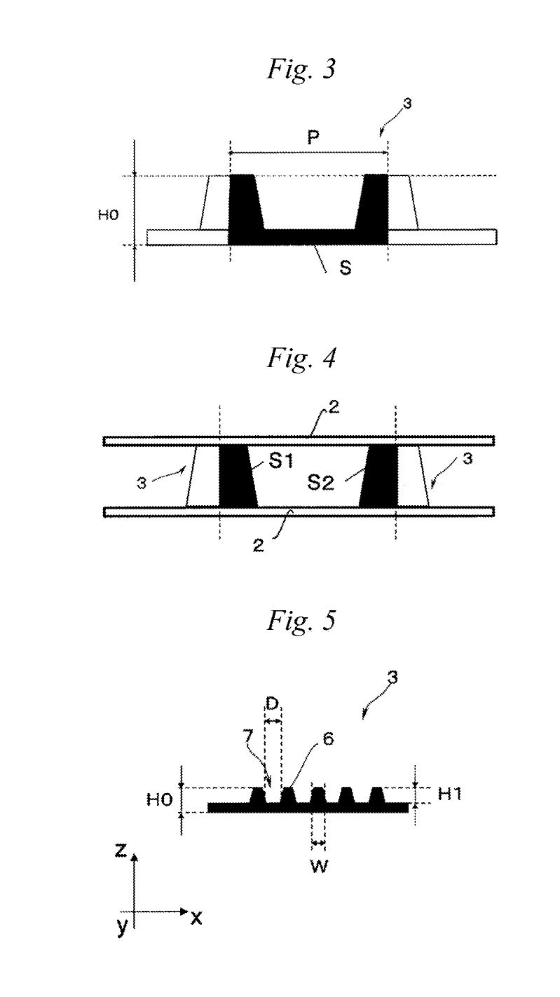

The cross-section area ratio of the permeate-side channel material is explained here. FIG. 3 shows a sheet-shaped permeate-side channel material as an example. After the permeate-side channel material is fitted into a separation membrane element, the element is cut along the longitudinal direction of the water collection tube so that the protrusions of the permeate-side channel material are cut. The resultant section is examined to determine the ratio of the cross-sectional area of the permeate-side channel material lying between the center of a protrusion and the center of an adjacent protrusion to the product of the height of the permeate-side channel material and the distance (also referred to as pitch) between the center of the former protrusion and the center of the adjacent protrusion. That ratio is the cross-section area ratio.

Also in the case where a permeate-side channel material has been bonded to the permeate-side face of a separation membrane as in FIG. 4, the cross-section area ratio can be calculated in the same manner. In this case, however, there are a plurality of portions of the channel material, and the permeate-side channel material lying between the center of a protrusion and the center of an adjacent protrusion has two cross-sectional areas (S1 and S2). The cross-sectional area S corresponds to the sum of S1 and S2.

In a specific method for determination, the permeate-side channel material is cut in the manner described above and the cross-section area ratio can be calculated using a microscopic-image analyzer.

<Production of Permeate-Side Channel Material>

A permeate-side channel material to be used in the present invention can be obtained, for example, by ejecting a molten resin into a given shape onto a nonwoven fabric to form projections on the nonwoven fabric. Also usable is a method in which a molten resin is ejected onto the permeate-side face of a separation membrane to obtain projections as a permeate-side channel material. Furthermore, a film or a sheet may be embossed or imprinted to obtain a rugged sheet for use as a permeate-side channel material.

<Increase in Raw-Water Flow Rate>

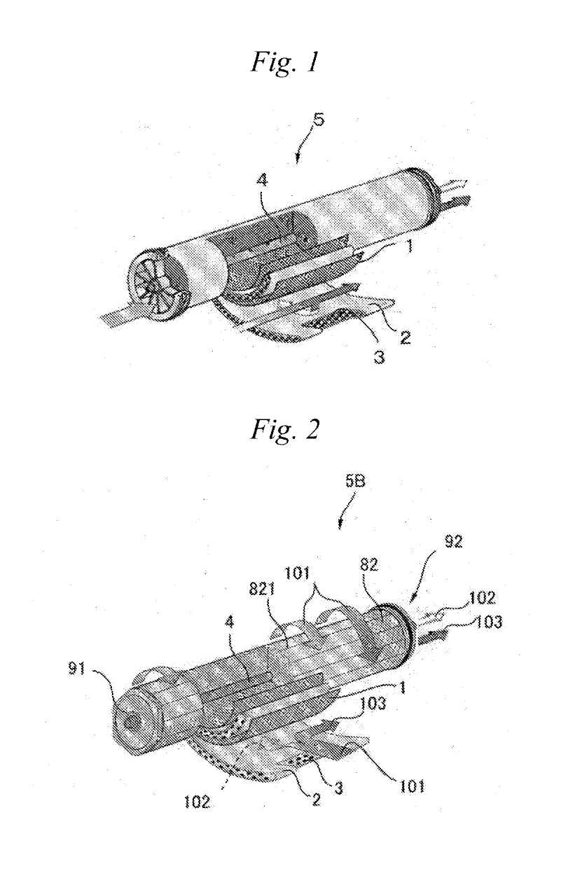

In cases when a raw-water-side channel formed by a raw-water-side channel material 1 extends at least in the winding direction of the separation membrane leaf, raw water can be passed at an increased flow rate as compared with the general separation membrane element 5 shown in FIG. 1, in which the raw-water-side channel extends in the width direction of the separation membrane element.

In the case of using a raw-water-side channel material having the same thickness, the area of the inlet of the raw-water-side channel in the general separation membrane element 5 is the product of the length L of the separation membrane leaf and the thickness H2 of the raw-water-side channel material. Meanwhile, in the case where a raw-water-side channel extends at least in the winding direction of the separation membrane leaf as in the present invention, the area of the inlet of the raw-water-side channel is the product of the width W1 of the separation membrane leaf and the thickness H2 of the raw-water-side channel material. Since the ratio between the width W1 of the separation membrane leaf and the winding-direction length L of the separation membrane leaf, L/W1, is 2.5 or larger, that is, since the length L of the separation membrane leaf is at least 2.5 times the width W1 of the separation membrane leaf, the separation membrane element of the present invention is smaller in the cross-sectional area of the raw-water feed part (cross-sectional area of the inlet of the raw-water-side channel). In cases when raw water is passed in the same amount through the separation membrane element of the present invention, the raw water flows therethrough at an increased rate.

The expression “a raw-water-side channel extends at least in the winding direction of the separation membrane leaf” means a configuration of the separation membrane leaf in which a raw-water inlet or outlet has been disposed in a region located on the opposite side from the water collection tube 4 along the winding direction.

Flow resistance increases in proportion to water amount and channel length. However, in the configuration according to the present invention, since a raw-water-side channel has been disposed so as to extend in the winding direction, the separation membrane element of the present invention tends to have higher flow resistance than the I-type element in main use (having a raw-water-side channel extending in the width direction of the separation membrane element). A general configuration for coping with the trend is one in which the number of separation membrane leaves is reduced and the length L of the raw-water-side channel (also referred to as the length of the separation membrane leaf) is reduced, thereby lowering the flow resistance. However, raw water is dispersed more by a degree corresponding to the increase in the number of the separation membrane leaves and, hence, the raw-water flow rate decreases, thereby increasing the ion concentration on the membrane surface. This separation membrane element is prone to suffer a decrease in salt removal ratio and prone to scaling. In the present invention, however, since the coefficient of variation in channel width is 0.00-0.10 as described earlier, friction between the permeate and the channel is reduced and this remarkably lowers the permeate-side resistance to enable the element to retain overall flow resistance even when the raw-water-side channel material forms an elongated raw-water-side channel and is in the state of being high in flow resistance. As a result, it is possible to provide a separation membrane element which has an increased raw-water flow rate and a high salt removal ratio and is less apt to suffer scaling.

Even in the case of configuring a separation membrane element in which the flow resistance has been lowered by reducing the number of separation membrane leaves in order to preferentially increase the fresh-water production rate, since this separation membrane element is higher in fresh-water production rate than a separation membrane element having a similar configuration but high flow resistance, raw water can be fed to this separation membrane element in an increased amount. The raw-water flow rate can hence be increased.

<Types of the Separation Membrane Element>

The separation membrane element of the present invention includes a separation membrane leaf in which a raw-water feed part or a concentrate discharge part has been disposed in a region located on the opposite side from the water collection tube 4 along the winding direction. Configurations of such separation membrane elements can be classified by the flow of raw water into L type, IL type, T type, etc. These types each can be configured so that raw water flows in the reverse direction, to constitute an inverted-L type, inverted-IL type, inverted-T type, etc. For example, a raw-water feed part in the L type is the concentrate discharge part in the inverted-L type.

<L-Type Separation Membrane Element>

An L-type element 5B according to the present invention is explained with reference to FIG. 2. The constituent elements which have been explained above are denoted by the same signs and explanations thereon are omitted here.

The L-type element 5B includes: an end plate 91 without holes which has been disposed at a first end of the element and has no holes; and an end plate 92 with holes which has been disposed at a second end of the element and has holes. The L-type element further includes a porous member 82 wound around the outermost surface of the wound separation membranes 2.

A process for producing the L-type element 5B is as follows. Specifically, a raw-water-side channel material 1 is sandwiched between separation membranes 2, and a permeate-side channel material 3 is superposed thereon to form one unit. Such units are spirally wound around a water collection tube 4. Thereafter, both ends are subjected to edge cutting, and a sealing plate (corresponding to the first end plate 91) for preventing the inflow of raw water through one end is attached. Furthermore, an end plate corresponding to the second end plate 92 is attached to the other end of the covered separation membrane element. Thus, a separation membrane element can be obtained.

As the porous member 82, use is made of a member having a plurality of holes capable of passing raw water therethrough. These holes 821 formed in the porous member 82 may be called raw-water feed openings. The porous member 82 is not particularly limited in the material, size, thickness, rigidity, etc. thereof so long as the porous member 82 has a plurality of holes. By employing a porous member 82 having a relatively small thickness, the membrane area per unit volume of the separation membrane element can be increased.

In FIG. 2, the holes 821 formed in the porous member 82 are shown as slits (linearly). However, the porous member 82 may have a structure in which a plurality of holes having a circular, quadrilateral, elliptic, triangular, or another shape have been arranged.

The thickness of the porous member 82 is, for example, preferably 1 mm or less, more preferably 0.5 mm or less, even more preferably 0.2 mm or less. The porous member 82 may be a member having such flexibility that the member can be deformed so as to conform to the peripheral shape of the separation membrane element. More specifically, a net, a porous film, or the like is applicable as the porous member 82. The net and the porous film may have been formed into a tubular shape so that the separation membrane element can be disposed therein, or may be continuous and have been wound around the separation membrane element.

The porous member 82 is disposed on the peripheral surface of the L-type element 5B. Such disposition of the porous member 82 makes the L-type element 5B have holes disposed in the peripheral surface. The term “peripheral surface” can means, in particular, that portion of the whole peripheral surface of the L-type element 5B which excludes the surfaces of the first end and second end mentioned above. In this embodiment, the porous member 82 is disposed so as to cover substantially the entire peripheral surface of the separation membrane element.

In the case where the L-type element 5B is operated in the state of having been loaded in a vessel, raw water does not flow into the L-type element 5B through the surface of the first end because the end plate disposed at the first end is the end plate 91 without holes. Raw water 101 flows into the gap between the vessel and the L-type element 5B. The raw water 101 is fed to the separation membranes 2 from the peripheral surface of the L-type element 5B via the porous member 82. The raw water 101 thus fed is separated by the separation membranes into a permeate 102 and a concentrate 103. The permeate 102 passes through the water collection tube 4 and is taken out through the second end of the L-type element 5B. The concentrate 103 passes through the holes of the end plate 92 with holes disposed at the second end and flows out from the L-type element 5B. Namely, the L-type element has a raw-water feed part disposed in a peripheral part of each separation membrane leaf and has a concentrate discharge part disposed in a one-side end face, in the longitudinal direction of the water collection tube, of each separation membrane leaf.

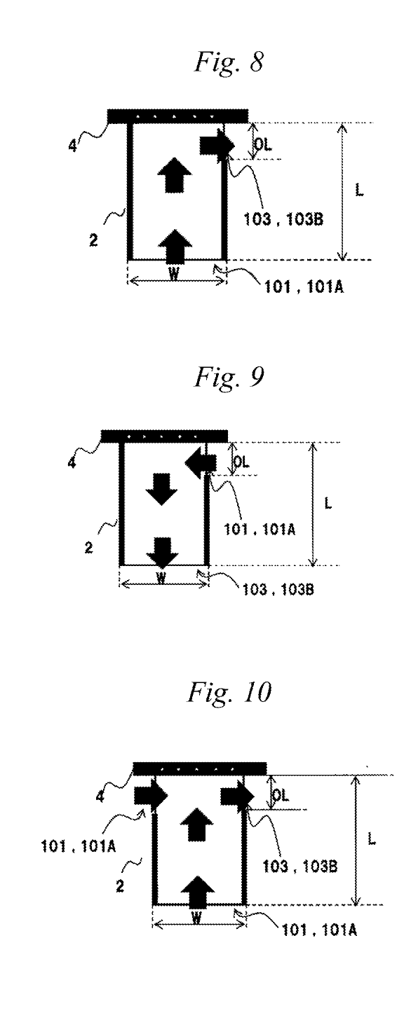

Furthermore, by reducing the size of the concentrate discharge parts, the flow of raw water in the raw-water-side channel can be made more even. Concentrate discharge parts may hence be disposed on the periphery of the water collection tube. Specifically, as shown in FIG. 8, the edge of each separation membrane leaf which lies on the concentrate-discharge-part side is sealed over the length L of the separation membrane leaf excluding the opening length OL (also referred to as “length of the opening”). Usable as a means of sealing is thermal fusion bonding, an adhesive, etc. By regulating the proportion of the opening length OL to the length L of the separation membrane leaf (referred to also as “opening ratio”) to preferably 5-35%, more preferably 15-25%, raw water can be caused to evenly flow through the channel. Although such disposition of the opening is efficient, the opening enables the effects of the present invention to be satisfactorily exhibited in other cases also. The separation membrane leaves are not limited to ones each having only one opening as shown in FIG. 8, and a plurality of openings may be formed in accordance with the quality of the raw water, flow rate of the raw water, and resultant resistance. In either case, the disposition of an opening in an inner end along the winding direction of the water collection tube is preferred because this renders raw water apt to flow evenly.

### <Inverted-L-Type Separation Membrane Element>

In this type, raw water is fed in the direction opposite from that in the L-type element. Namely, the concentrate discharge part in the L-type element is a raw-water feed part, and the raw-water feed part in the L-type element is a concentrate discharge part. The members used in the inverted-L-type element 5C may be the same as in the L-type element 5B. Namely, the inverted-L-type element has a raw-water feed part disposed in a one-side end face, in the longitudinal direction of the water collection tube, of each separation membrane leaf and has a concentrate discharge part disposed in a peripheral part, in the winding direction, of each separation membrane leaf.

In this type, by reducing the size of the raw-water feed part, the flow of raw water through the raw-water-side channel can be made more even. As shown in FIG. 9, the edge of each separation membrane leaf which lies on the raw-water-feed-part side is sealed over the length L of the separation membrane leaf excluding the opening length OL. Usable as a means of sealing is thermal fusion bonding, an adhesive, etc. By regulating the proportion of the opening length OL to the length L of the separation membrane leaf to preferably 10-40%, more preferably 15-20%, raw water can be caused to evenly flow through the channel. Although such disposition of the opening is efficient, the opening enables the effects of the present invention to be satisfactorily exhibited in other cases also. The separation membrane leaves are not limited to ones each having only one opening as shown in FIG. 9, and a plurality of openings may be formed in accordance with the quality of the raw water and the flow rate of the raw water. In either case, the disposition of an opening in an inner end along the winding direction is preferred because this renders raw water apt to flow evenly.

### <IL-Type Separation Membrane Element>

With respect to an IL-type element 5D according to the present invention, the members to be used therein and the length of each opening is substantially the same as in the L-type element.

Using FIG. 10, an explanation is given mainly on specific flows of raw water. In the IL-type element, the end plate 91 without holes disposed at the first end of the L-type element has been replaced with an end plate 92 with holes, and raw water 101 flows thereinto through both the peripheral surface and the first end of the separation membrane element. Namely, in the IL-type element, each separation membrane leaf has two raw-water feed parts disposed respectively in a one-side end face thereof in the longitudinal direction of the water collection tube and in a peripheral part thereof in the winding direction, and further has a concentrate discharge part disposed in an end face thereof on the other side in the longitudinal direction of the water collection tube. Due to this configuration, the flow resistance of the raw-water-side channel is reduced although the flow rate of raw water is lower than in the L-type element.

### <T-Type Separation Membrane Element>

In a T-type element, raw water 101 is fed from both width-direction ends of the T-type element 5E through end plates 92 with holes. Thereafter, the raw water 101 is separated by the separation membranes into a permeate 102 and a concentrate 103, and the permeate 102 passes through the water collection tube 4 and is taken out through the first end or both ends of the T-type element 5E. Meanwhile, the concentrate 103 is discharged through the peripheral surface of the T-type element 5E. Namely, the T-type element has two raw-water feed parts disposed respectively in the both-side end faces, in the longitudinal direction of the water collection tube, of each separation membrane leaf and has a concentrate discharge part disposed in a peripheral part, in the winding direction, of each separation membrane leaf.

In this type, the flow of raw water through the raw-water-side channel can be made more even by reducing the size of the concentrate discharge part, as in other types. The two edges of each separation membrane leaf which lie on the raw-water-feed side are each sealed over the length L of the separation membrane leaf excluding the opening length OL. Usable as a means of sealing is thermal fusion bonding, an adhesive, etc. By regulating the proportion of the opening length OL to the length L of the separation membrane leaf to preferably 5-45%, more preferably 15-30%, raw water can be caused to evenly flow through the channel. Although such disposition of the opening is efficient, the opening enables the effects of the present invention to be satisfactorily exhibited in other cases also. The separation membrane leaves are not limited to ones each having only two openings, and a plurality of openings may be formed in accordance with the quality of the raw water and the flow rate of the raw water. In either case, the disposition of an opening in an inner end along the winding direction is preferred because this renders raw water apt to flow evenly. Although there are two openings, the openings may differ in length. The element having this configuration can be operated so that raw water flows in the opposite direction, as shown in FIG. 11.

### <Decrease in Fresh-Water Production Rate Due to Scaling>

In cases when a separation membrane is continuously operated and scaling has occurred on a surface of the separation membrane, the scale offers resistance in the filtration, resulting in a decrease in the fresh-water production rate of the separation membrane element. Since the scale grows continuously, whether scaling has occurred or not can be presumed by determining a change in fresh-water production rate from initiation of the operation. Examples of indexes include a decrease in fresh-water production rate, which can be expressed by a change in fresh-water production rate from after 1 hour from initiation of the operation to after 100 hours therefrom, i.e., 100-[(fresh-water production rate after 100 hours)/(fresh-water production rate after 1 hour)]×100. The closer the value thereof to 0, the less the surface of the separation membrane suffers scaling and the better the performance stability of the separation membrane element in high-recovery ratio operations.

### <Length of Separation Membrane Leaves (Membrane Leaf Length)>

Separation membranes are packed into a separation membrane element, in the state of separation membrane leaves (also referred to simply as “membrane leaves” or “leaves”) in each of which separation membranes have been disposed so that the raw-water-side faces face each other. With respect to the length of each separation membrane leaf (also referred to as “membrane leaf length”), the permeate-side channel material applied to the present invention can keep the permeate-side resistance low and, hence, the permeate-side resistance remains low even when the membrane leaf length is increased. Because of this, it is possible to reduce the number of membrane leaves and increase the membrane leaf length. As the number of membrane leaves is reduced, the number of raw-water channel inlets decreases in an amount corresponding to the number of the removed membrane leaves. However, since raw water is fed at substantially the same rate, the flow rate of the raw water can be further increased. It is however preferable that the membrane leaf length is 750 mm to 2,000 mm because the flow resistance becomes higher as the membrane leaf length increases.

### <Flow Rate of Raw Water>

The flow rate of raw water can be calculated by dividing the amount of the raw water fed in a unit time by the cross-sectional area of the inlet of the raw-water-side channel. The cross-sectional area of the inlet of the raw-water-side channel is the product of the membrane width in the separation membrane element (i.e., the length, in the longitudinal direction of the water collection tube, of the separation membrane leaf), the thickness of the raw-water-side channel material, and the porosity of the raw-water-side channel material.

<Thickness of Permeate-Side Channel Material>

The thickness H0 of the permeate-side channel material in FIG. 5 is preferably 0.1 mm to 1 mm. Although film thickness measuring devices of various types including the electromagnetic, ultrasonic, magnetic, and light transmission types are commercially available, the thickness of the channel material may be measured with any of non-contact types. A measurement is randomly made on ten portions, and an average of these is used for evaluation. In cases when the thickness of the permeate-side channel material is 0.1 mm or larger, this channel material has strength required for permeate-side channel materials and can be handled without collapsing or breaking even under stress. In cases where the thickness thereof is 1 mm or less, the number of separation membranes or channel materials which can be inserted into a pressure vessel can be increased without impairing the windability around the water collection tube.

In the case of a permeate-side channel material bonded to the permeate-side face of a separation membrane, such as that shown in FIG. 4, the thickness H0 of this permeate-side channel material is the same as the height H1 of protrusions of the permeate-side channel material, which will be described below.

<Protrusion Height, Groove Width, and Groove Length in Permeate-Side Channel Material>

In the permeate-side channel material shown in FIG. 5, the height H1 of the protrusions is preferably 0.05 mm to 0.8 mm, and the groove width D is preferably 0.02 mm to 0.8 mm. The height of the protrusions and the groove width D can be measured by examining a cross-section of the permeate-side channel material with a commercial microscope or the like.

Because the space formed by the height of the protrusions, the groove width D, and the overlying separation membrane serves as a channel and because the height of the protrusions and the groove width D are within those ranges, flow resistance can be reduced while inhibiting membrane sinking during pressure filtration. Thus, a separation membrane element excellent in terms of pressure resistance and fresh-water production performance can be obtained.

In the case where protrusions are disposed apart from each other in each of the MD and CD, such as protrusions in the shape of dots (see FIG. 6), the groove length E can be set like the groove width D.

### <Width and Length of Protrusions of Permeate-Side Channel Material>

In the permeate-side channel material shown in FIG. 5, the width W of the protrusions is preferably 0.1 mm or larger, more preferably 0.3 mm or larger. In cases when the width W thereof is 0.1 mm or larger, the permeate-side channel material can retain the shape of the protrusions to stably form a permeate-side channel, even when pressure is applied to the permeate-side channel material during operations of the separation membrane element. The width W thereof is preferably 1 mm or less, more preferably 0.7 mm or less. In cases when the width W thereof is 1 mm or less, a channel on the permeate side of the separation membrane can be sufficiently ensured.

The width W of protrusions 6 is measured in the following manner. First, with respect to a cross-section perpendicular to a first direction (CD of the separation membrane), an average value of a maximum width and a minimum width of one protrusion 6 is calculated. Specifically, in the case of a protrusion 6 which has a thin upper portion and a thick lower portion, such as those shown in FIG. 5, the width of the lower portion of the protrusion and the width of the upper portion thereof are measured and an average value of these is calculated. Such average value is calculated for cross-sections of at least thirty portions and an arithmetical mean is calculated therefrom. Thus, the width W for one membrane can be calculated.

In the case where protrusions are disposed apart from each other in each of the MD and CD, such as protrusions in the shape of dots (see FIG. 6), the length X can be set like the width W.

<Material of Permeate-Side Channel Material>

Usable forms of the sheet-shaped object include a knitted fabric, a woven fabric, a porous film, a nonwoven fabric, a net, and the like. Especially in the case of a nonwoven fabric, the fibers constituting the nonwoven fabric form large spaces thereamong which serve as a channel, and this renders the flow of water easy, resulting in an improvement in the fresh-water production performance of the separation membrane element. Use of a nonwoven fabric is hence preferred.

The polymer itself which is the material of the permeate-side channel material is not particularly limited so long as the permeate-side channel material retains its shape and component dissolution therefrom in the permeate is little. Examples thereof include synthetic resins such as polyamide-based polymers, e.g., nylons, polyester-based polymers, polyacrylonitrile-based polymers, polyolefin-based polymers, e.g., polyethylene and polypropylene, polyvinyl chloride-based polymers, polyvinylidene chloride-based polymers, and polyfluoroethylene-based polymers. It is, however, preferred to use a polyolefin-based polymer or a polyester-based polymer especially from the standpoints of strength for withstanding higher pressures and of hydrophilicity.

In the case of using a sheet-shaped object configured of a plurality of fibers, the fibers may be ones having, for example, a polypropylene/polyethylene core-sheath structure.

<Channel by Permeate-Side Channel Material>

In cases when a separation membrane has been disposed on each of both faces of the permeate-side channel material, the space between a protrusion and an adjacent protrusion can serve as a channel for permeate. The channel may be one formed with the permeate-side channel material which itself has been formed in the shape of a corrugated sheet, rectangular waves, triangular waves, or the like, or with the permeate-side channel material in which one face is flat and the other face has been rugged, or with the permeate-side channel material which has another member superposed on a surface thereof so as to form a rugged shape.

<Shape of Permeate-Side Channel Material>

The permeate-side channel material according to the present invention may be one in which the protrusions for forming a channel are in the shape of dots such as those shown in FIG. 6. With respect to arrangements of dots, a zigzag arrangement is advantageous for inhibiting sinking because stress caused by receiving pressurized raw water is dispersed. Although cylindrical projections having a circular cross-section (which is parallel with the plane of the sheet) are shown in FIG. 6, the cross-section is not particularly limited and may be polygonal, elliptic, etc. Protrusions differing in cross-sectional shape may coexist. The protrusions may have a rugged shape which includes continuous grooves arranged in parallel in one direction, such as that shown in FIG. 7.

The protrusions may be trapezoidal walls having a cross-sectional shape, along a direction perpendicular to the winding direction, in which the width changes, or may be ones having the shape of an elliptic column, elliptic cone, quadrangular pyramid, hemisphere, or the like.

<Water Treatment System>

The separation membrane element of the present invention is applicable, for example, to water treatment systems such as RO water purifiers.

<Raw-Water-Side Channel Material>

The raw-water-side channel material to be used in the present invention can be, for example, a net, a rugged sheet, or projections disposed on the raw-water-side face of a separation membrane.

With respect to the thicknesses of such raw-water-side channel materials, larger thicknesses are preferred from the standpoint of reducing the resistance of the raw-water-side channel. In the present invention, however, the permeate-side resistance is low and, hence, even when the raw-water-side channel material has a reduced thickness, the fresh-water production rate of the separation membrane element can be kept high. Because of this, the thickness of the raw-water-side channel material can be 0.15 mm or larger. Meanwhile, the smaller the thickness thereof, the larger the amount of separation membranes which can be included in the separation membrane element. The thickness thereof can hence be 0.9 mm or less.

For these reasons, the thickness of the raw-water-side channel material is preferably 0.15 mm to 0.9 mm, more preferably 0.28 mm to 0.8 mm.

### EXAMPLES

The present invention is described below in more detail with reference to the following Examples. However, the present invention should not be construed as being limited by these Examples. The term “opening ratio” in the tables means the opening ratio of the concentrate discharge parts in the case of each inverted-L-type separation membrane element or means the opening ratio of the raw-water feed parts in the case of each separation membrane element of any other type.

### (Thickness of Permeate-Side Channel Material and Height of Protrusions)

The thickness of the permeate-side channel material and the height of the protrusions were measured with high-precision configuration analysis system “KS-1100”, manufactured by KEYENCE CORPORATION. Specifically, using the high-precision configuration analysis system “KS-1100”, manufactured by KEYENCE CORPORATION, the average height difference was analyzed from the measurement results for 5 cm×5 cm. Thirty points with a height difference of 10 μm or more were examined and the respective height values were totaled. The total was divided by the number of the total number of measurement points (thirty points). The resulting value was taken as the height of the protrusions.

### (Width and Length of Protrusions and Groove Width and Groove Length of Recesses in Permeate-Side Channel Material)

Using the high-precision configuration analysis system “KS-1100”, manufactured by KEYENCE CORPORATION, the widths and the lengths were determined in the same manner as for the thickness of the permeate-side channel material and the height of the protrusions described above.

### (Pitch of Protrusions of Permeate-Side Channel Material)

After the permeate-side channel material was fitted into a separation membrane element, the element was cut along the longitudinal direction of the water collection tube so that the protrusions of the permeate-side channel material were cut, thereby obtaining a sample. This sample was examined from over the protrusions with the high-precision configuration analysis system “KS-1100”, manufactured by KEYENCE CORPORATION. The horizontal distance between the center of a protrusion and the center of an adjacent protrusion was measured with respect to 200 portions, and an average value of these was taken as the pitch.

(Channel Width of Permeate-Side Channel Material) A value obtained by subtracting the half width of one protrusion and the half width of the other protrusion from the pitch of protrusions obtained by the method described above was taken as the channel width.

### (Coefficient of Variation in Channel Width)

With respect to the same channel, a hundred portions were examined for channel width at intervals of 0.25 mm along the winding direction, and the standard deviation thereof was divided by the average value thereof. The resultant value is the coefficient of variation in channel width of the one channel. Likewise, the same operation was repeated with respect to other fifty channels to calculate the coefficient of variation in channel width of each channel. These coefficients of variation were averaged, and the average value was taken as the coefficient of variation in channel width.

### (Cross-Section Area Ratio of Permeate-Side Channel Material)

After the permeate-side channel material was fitted into a separation membrane element, the element was cut along the longitudinal direction of the water collection tube so that the protrusions of the permeate-side channel material were cut. The resultant cross-section was examined with the high-precision configuration analysis system “KS-1100”, manufactured by KEYENCE CORPORATION, to calculate the ratio of the cross-sectional area of the permeate-side channel material lying between the center of a protrusion and the center of an adjacent protrusion to the product of the height of the permeate-side channel material and the distance between the center of the former protrusion and the center of the adjacent protrusion. An average value for arbitrarily selected thirty portions was taken as the cross-section area ratio.

### (Fresh-Water Production Rate)

The separation membrane element was operated under the conditions of an operation pressure of 0.41 Pa and a temperature of 25° C. for 15 minutes using an aqueous sodium chloride solution having a concentration of 200 ppm and having a pH of 6.5 as raw water. Thereafter, sampling was performed for 1 minute, and the water permeation amount (gallons) per day was expressed as fresh-water production rate (GPD (gallons/day)).

### (Recovery Ratio)

The proportion between the amount of raw water V_{F} fed in a given time period and the amount of permeate V_{P} obtained in that time period, in the measurement of fresh-water production rate, was taken as the recovery ratio and calculated using V_{P}/V_{F}×100.

### (Removal Ratio (TDS Removal Ratio))

The raw water used for the 1-minute operation in the measurement of fresh-water production rate and the permeate obtained by sampling were examined for TDS concentration by a conductivity measurement. The TDS removal ratio was calculated using the following formula.

TDS removal ratio (%)=100×{1−[(TDS concentration in permeate)/(TDS concentration in raw water)]}

### (Decrease in Fresh-Water Production Rate)

The decrease is a change in fresh-water production rate from after 1 hour from initiation of an operation to after 100 hours therefrom, and is expressed by 100-[(fresh-water production rate after 100 hours)/(fresh-water production rate after 1 hour)]×100. The closer the value thereof to 0, the less the surface of the separation membrane suffers scaling and the better the performance stability of the separation membrane element in high-recovery operations.

(Production of Permeate-Side Channel Material Including Nonwoven Fabric with Projections Thereon)

An applicator equipped with a comb-shaped shim having a slit width of 0.5 mm and a pitch of 0.9 mm was used to linearly apply pellets of a composition containing 60% by mass highly crystalline PP (MFR, 1,000 g/10 min; melting point, 161° C.) and 40% by mass lowly crystalline α-olefin-based polymer (lowly stereoregular polypropylene “L-MODU⋅S400” (trade mane), manufactured by Idemitsu Kosan Co., Ltd.) to a surface of a nonwoven fabric at a resin temperature of 205° C. and a travelling speed of 10 m/min while regulating the temperature of the back-up roll to 20° C., so as to result in linear projections which, in a separation membrane element, were perpendicular to the longitudinal direction of the water collection tube and which, in an envelope-shaped membrane, were perpendicular to the longitudinal direction of the water collection tube from the inside end to the outside end along the winding direction. The nonwoven fabric had a thickness of 0.07 mm and a basis weight of 35 g/m² and had an embossed pattern (circular dots with a diameter of 1 mm, disposed in a lattice arrangement with a pitch of 5 mm).

In the tables, this permeate-side channel material is indicated by permeate-side channel material “A”.

### (Production of Permeate-Side Channel Material Bonded to Permeate-Side Face of Separation Membrane)

A permeate-side channel material was disposed in the same manner as for the permeate-side channel material including nonwoven fabric with projections thereon, except that the nonwoven fabric was replaced with a separation membrane to disposed projections on the permeate-side face of the separation membrane.

In the tables, this permeate-side channel material is indicated by permeate-side channel material “B”.

### (Production of Permeate-Side Channel Material Including Film Having Through Holes)

An unstretched polypropylene film (Torayfan (registered trademark), manufactured by Toray Inc.) was subjected to imprinting and CO₂ laser processing to obtain a permeate-side channel material having through holes. Specifically, the unstretched polypropylene film was sandwiched with a metallic die having grooves formed by machining, and was kept being pressed at 15 MPa and 140° C. for 2 minutes, cooled to 40° C., and then removed from the die.

Subsequently, using 3D-axis CO₂ laser marker MLZ9500, the rugged imprinted sheet was processed from the non-rugged-face side so that the recesses in the rugged sheet were processed with laser beams, thereby obtaining through holes. The through holes were formed in each groove at a pitch of 2 mm.

In the tables, this permeate-side channel material is indicated by permeate-side channel material “C”.

(Production of Permeate-Side Channel Material from Weft Knitted Fabric)

A weft knitted fabric was obtained using a multifilament yarn (48 filaments; 110 dtex), as a knitting yarn, constituted of a mixture of polyethylene terephthalate filaments (melting point, 255° C.) and polyethylene terephthalate-based low-melting-point filaments (melting point, 235° C.), by forming a plan weft knitted fabric (gauge (number of needles in unit length of the knitting machine)). This weft knitted fabric was heat-set at 245° C. and then calendered to thereby produce the permeate-side channel material.

In the tables, this permeate-side channel material is indicated by permeate-side channel material “D”.

### Example 1

A 15.2% by mass DMF solution of a polysulfone was cast in a thickness of 180 μm on a nonwoven fabric made of polyethylene terephthalate fibers (fiber diameter, 1 dtex; thickness, about 0.09 mm; density, 0.80 g/cm³) at room temperature (25° C.). Immediately thereafter, the fabric was immersed in pure water and allowed to stand therein for 5 minutes, and was then immersed in 80° C. hot water for 1 minute, thereby producing a porous supporting layer (thickness, 0.13 mm) including a fiber-reinforced polysulfone supporting membrane.

Thereafter, the porous supporting layer roll was unwound and immersed in a 3.8% by weight aqueous solution of m-PDA for 2 minutes. The supporting membrane was slowly pulled up vertically, and nitrogen was blown thereagainst from an air nozzle to remove the excess aqueous solution from the surface of the supporting membrane. Thereafter, an n-decane solution containing 0.175% by weight trimesoyl chloride was applied thereto so that the surface was completely wetted, and this coated membrane was allowed to stand still for 1 minute. Next, the membrane was held vertically for 1 minute to remove the excess solution from the membrane. Thereafter, the membrane was cleaned with 90° C. hot water for 2 minutes, thereby obtaining a separation membrane roll.

The separation membrane thus obtained was folded and cut so as to result in an effective area in a separation membrane element of 0.5 m², and a net (thickness, 0.5 mm; pitch, 3 mm×3 mm; fiber diameter, 250 μm; projected area ratio, 0.25) was used as a raw-water-side channel material to produce one leaf shown in Table 1.

The permeate-side channel material shown in Table 1 was superposed on a permeate-side face of the resulting leaf, and this stack was spirally wound around an ABS (acrylonitrile-butadiene-styrene) water collection tube (width, 350 mm; diameter 18 mm; number of holes, 10 holes×one linear line). The peripheral surface of the separation membrane element was covered with a tubular net formed by continuous extrusion molding (thickness, 0.5 mm; pitch, 2 mm×2 mm; fiber diameter, 0.25 mm; projected area ratio, 0.21). Both ends of the covered separation membrane element were subjected to edge cutting. Thereafter, a sealing plate (corresponding to a first end plate 91) for preventing raw-water inflow through one end was attached. Thus, a raw-water feed port was disposed only in the peripheral surface of the separation membrane element (L-type element). Furthermore, an end plate corresponding to a second end plate 92 was attached to the other end of the covered separation membrane element, thereby producing a separation membrane element having a diameter of 2 inches and having a concentrate fluid outlet disposed at the other end of the separation membrane element.

The separation membrane element was loaded in a pressure vessel and evaluated for performances at a recovery ratio of 90% under the conditions shown above. The results were as shown in Table 1.

TABLE 1

| | | Example 1 | Example 2 | Example 3 | Example 4 | Example 5 | Example 6 |
|---|---|---|---|---|---|---|---|
| Separation | Type | L type | L type | L type | L type | L type | L type |
| membrane | Element diameter | 2 inches | 2 inches | 2 inches | 2 inches | 2 inches | 2 inches |
| element | Position of raw-water feed part | periphery | periphery | periphery | periphery | periphery | periphery |
| | | side | side | side | side | side | side |
| | Position of concentrate discharge part | end face | end face | end face | end face | end face | end face |
| | | side | side | side | side | side | side |
| | Width (mm) | 230 | 230 | 230 | 230 | 230 | 230 |
| | Membrane leaf length (mm) | 1000 | 1000 | 1000 | 1000 | 1000 | 1000 |
| | Membrane leaf length/width (L/W1) | 4.3 | 4.3 | 4.3 | 4.3 | 4.3 | 4.3 |
| | Number of membrane leaves (pieces) | 1 | 1 | 1 | 1 | 1 | 1 |
| | Effective membrane area (m²) | 0.46 | 0.46 | 0.46 | 0.46 | 0.46 | 0.46 |
| Feed-side | Inlet width (mm) | 230 | 230 | 230 | 230 | 230 | 230 |
| channel | Inlet thickness (mm) | 0.5 | 0.5 | 0.5 | 0.5 | 0.5 | 0.5 |
| | Opening ratio (%) | 20 | 20 | 20 | 20 | 20 | 20 |
| | Length (mm) | 1000 | 1000 | 1000 | 1000 | 1000 | 1000 |
| Permeate-side | Kind | A | A | B | C | A | A |
| channel material | Thickness H0 (mm) | 0.30 | 0.30 | 0.30 | 0.30 | 0.30 | 0.30 |
| | Cross-section area ratio | 0.65 | 0.65 | 0.65 | 0.65 | 0.65 | 0.56 |
| Protrusions of | Plan-view shape | linear (MD) | linear (MD) | linear (MD) | linear (MD) | linear (MD) | linear (MD) |
| permeate-side | Height H1 (mm) | 0.23 | 0.23 | 0.23 | 0.23 | 0.23 | 0.23 |
| channel | Width W (mm) | 0.37 | 0.37 | 0.37 | 0.37 | 0.37 | 0.37 |
| material | Coefficient of variation in channel | 0.08 | 0.05 | 0.05 | 0.02 | 0.03 | 0.03 |
| | width (—) | | | | | | |
| | Length X (mm) | — | — | — | — | — | — |
| Recesses of permeate- | Groove width D (mm) | 0.40 | 0.40 | 0.40 | 0.40 | 0.40 | 0.62 |
| side channel material | Groove length E (mm) | — | — | — | — | — | — |
| Operation conditions | Recovery ratio (%) | 90 | 90 | 90 | 90 | 90 | 90 |
| Performance | Fresh-water production rate (GPD) | 96 | 99 | 105 | 97 | 100 | 108 |
| | Removal ratio (%) | 98.1 | 97.8 | 98.0 | 98.0 | 98.0 | 98.0 |
| | Decrease in fresh-water production rate | 13 | 13 | 14 | 16 | 14 | 13 |
| | (%) | | | | | | |

### Examples 2 to 10

Separation membranes and separation membrane elements were produced in the same manner as in Example 1, except that the permeate-side channel material was replaced with those shown in Tables 1 and 2.

The separation membrane elements were each loaded in a pressure vessel and evaluated for performances under the same conditions as in Example 1. The results were as shown in Tables 1 and 2.

TABLE 2

| | | Example 7 | Example 8 | Example 9 | Example 10 | Example 11 | Example 12 |
|---|---|---|---|---|---|---|---|
| Separation | Type | L type | L type | L type | L type | L type | L type |
| membrane | Element diameter | 2 inches | 2 inches | 2 inches | 2 inches | 4 inches | 4 inches |
| element | Position of raw-water feed part | periphery | periphery | periphery | periphery | periphery | periphery |
| | | side | side | side | side | side | side |
| | Position of concentrate discharge part | end face side | end face side | end face side | end face side | end face side | end face side |
| | Width (mm) | 230 | 230 | 230 | 230 | 400 | 400 |
| | Membrane leaf length (mm) | 1000 | 1000 | 1000 | 1000 | 1000 | 1300 |
| | Membrane leaf length/width (L/W1) | 4.3 | 4.3 | 4.3 | 4.3 | 2.5 | 3.3 |
| | Number of membrane leaves (pieces) | 1 | 1 | 1 | 1 | 4 | 3 |
| | Effective membrane area (m²) | 0.46 | 0.46 | 0.46 | 0.46 | 3.20 | 3.12 |
| Feed-side | Inlet width (mm) | 230 | 230 | 230 | 230 | 400 | 400 |
| channel | Inlet thickness (mm) | 0.5 | 0.5 | 0.5 | 0.5 | 0.5 | 0.5 |
| | Opening ratio (%) | 20 | 20 | 20 | 20 | 20 | 20 |
| | Length (mm) | 1000 | 1000 | 1000 | 1000 | 1000 | 1300 |
| Permeate-side | Kind | B | C | D | D | A | A |
| channel material | Thickness H0 (mm) | 0.30 | 0.30 | 0.35 | 0.45 | 0.30 | 0.30 |
| | Cross-section area ratio | 0.40 | 0.65 | 0.74 | 0.70 | 0.65 | 0.65 |
| Protrusions of | Plan-view shape | linear (MD) | linear (MD) | — | — | linear (MD) | linear (MD) |
| permeate-side | Height H1 (mm) | 0.30 | 0.23 | — | — | 0.23 | 0.23 |
| channel material | Width W (mm) | 0.37 | 0.37 | — | — | 0.37 | 0.37 |
| | Coefficient of variation in channel | 0.03 | 0.00 | 0.10 | 0.10 | 0.03 | 0.03 |
| | width (—) | | | | | | |
| | Length X (mm) | — | — | — | — | — | — |
| Recesses of permeate- | Groove width D (mm) | 0.42 | 0.40 | — | — | 0.40 | 0.40 |
| side channel material | Groove length E (mm) | — | — | — | — | — | — |
| Operation conditions | Recovery ratio (%) | 90 | 90 | 90 | 90 | 90 | 90 |
| Performance | Fresh-water production rate (GPD) | 115 | 98 | 94 | 96 | 678 | 655 |
| | Removal ratio (%) | 98.0 | 98.0 | 98.1 | 98.0 | 98.0 | 98.0 |
| | Decrease in fresh-water production rate | 11 | 15 | 17 | 16 | 18 | 16 |
| | (%) | | | | | | |

### Examples 11 to 15

Separation membranes and separation membrane elements were produced in the same manner as in Example 1, except that the size and number of leaves were changed as shown in Tables 2 and 3.

The separation membrane elements were each loaded in a pressure vessel and evaluated for performances under the same conditions as in Example 1. The results were as shown in Tables 2 and 3.

TABLE 3

| | | Example 13 | Example 14 | Example 15 | Example 16 | Example 17 | Example 18 |
|---|---|---|---|---|---|---|---|
| Separation | Type | L type | L type | L type | L type | L type | L type |
| membrane | Element diameter | 3 inches | 3 inches | 2 inches | 2 inches | 2 inches | 2 inches |
| element | Position of raw-water feed part | periphery | periphery | periphery | periphery | periphery | periphery |
| | | side | side | side | side | side | side |
| | Position of concentrate discharge part | end face side | end face side | end face side | end face side | end face side | end face side |
| | Width (mm) | 300 | 300 | 230 | 230 | 230 | 230 |
| | Membrane leaf length (mm) | 800 | 1200 | 600 | 1000 | 1000 | 1000 |
| | Membrane leaf length/width (L/W1) | 2.7 | 4.0 | 2.6 | 4.3 | 4.3 | 4.3 |
| | Number of membrane leaves (pieces) | 3 | 2 | 2 | 1 | 1 | 1 |
| | Effective membrane area (m²) | 1.44 | 1.44 | 0.55 | 0.46 | 0.46 | 0.46 |
| Feed-side | Inlet width (mm) | 300 | 300 | 230 | 230 | 230 | 230 |
| channel | Inlet thickness (mm) | 0.5 | 1 | 0.35 | 0.5 | 0.5 | 0.5 |
| | Opening ratio (%) | 20 | 20 | 20 | 20 | 20 | 8 |
| | Length (mm) | 800 | 1200 | 600 | 1000 | 1000 | 1000 |
| Permeate-side | Kind | A | A | A | A | A | A |
| channel material | Thickness H0 (mm) | 0.30 | 0.30 | 0.30 | 0.30 | 0.30 | 0.30 |
| | Cross-section area ratio | 0.65 | 0.65 | 0.65 | 0.65 | 0.56 | 0.56 |
| Protrusions of | Plan-view shape | linear (MD) | linear (MD) | linear (MD) | linear (MD) | linear (MD) | linear (MD) |
| permeate-side | Height H1 (mm) | 0.23 | 0.23 | 0.23 | 0.23 | 0.23 | 0.23 |
| channel material | Width W (mm) | 0.37 | 0.37 | 0.37 | 0.37 | 0.37 | 0.37 |
| | Coefficient of variation in channel | 0.03 | 0.03 | 0.03 | 0.03 | 0.03 | 0.03 |
| | width (—) | | | | | | |
| | Length X (mm) | — | — | — | — | — | — |
| Recesses of | Groove width D (mm) | 0.40 | 0.40 | 0.40 | 0.40 | 0.62 | 0.40 |
| permeate-side | Groove length E (mm) | — | — | — | — | — | — |
| Channel material | | | | | | | |
| Operation conditions | Recovery ratio (%) | 90 | 90 | 90 | 60 | 35 | 90 |
| Performance | Fresh-water production rate (GPD) | 481 | 470 | 113 | 101 | 103 | 95 |
| | Removal ratio (%) | 98.0 | 98.2 | 98.3 | 98.1 | 98.4 | 98.1 |
| | Decrease in fresh-water production rate | 11 | 10 | 9 | 7 | 3 | 16 |
| | (%) | | | | | | |

### Examples 16 and 17

The same separation membrane element as that produced in Example 1 was loaded in a pressure vessel and evaluated for performances under the same conditions as in Example 1, except that the recovery ratio was changed to 60% in Example 16 and 35% in Example 17. The results were as shown in Table 3.

### Examples 18 and 19

Separation membranes and separation membrane elements were produced in the same manner as in Example 1, except that the opening ratio of the raw-water-side channel was changed as shown in Tables 3 and 4.

The separation membrane elements were each loaded in a pressure vessel and evaluated for performances under the same conditions as in Example 1. The results were as shown in Tables 3 and 4.

TABLE 4

| | | Example 19 | Example 20 | Example 21 | Example 22 | Example 23 | Example 24 |
|---|---|---|---|---|---|---|---|
| Separation | Type | L type | IL type | IL type | inverted- | inverted- | inverted- |
| membrane | | | | | L type | L type | L type |
| element | Element diameter | 2 inches | 2 inches | 2 inches | 2 inches | 2 inches | 2 inches |
| | Position of raw-water feed part | periphery | periphery | periphery | end face | end face | end face |
| | | side | side | side | side | side | side |
| | Position of concentrate discharge part | end face side | end face side | end face side | periphery | periphery | periphery |
| | | | | | side | side | side |
| | Width (mm) | 230 | 230 | 230 | 230 | 230 | 230 |
| | Membrane leaf length (mm) | 1000 | 1000 | 1000 | 1000 | 1000 | 1000 |
| | Membrane leaf length/width (L/W1) | 4.3 | 4.3 | 4.3 | 4.3 | 4.3 | 4.3 |
| | Number of membrane leaves (pieces) | 1 | 1 | 1 | 1 | 1 | 1 |
| | Effective membrane area (m²) | 0.46 | 0.46 | 0.46 | 0.46 | 0.46 | 0.46 |
| Feed-side | Inlet width (mm) | 230 | 230 | 230 | 230 | 230 | 230 |
| channel | Inlet thickness (mm) | 0.5 | 0.5 | 0.5 | 0.5 | 0.5 | 0.5 |
| | Opening ratio (%) | 35 | 15 | 30 | 10 | 20 | 40 |
| | Length (mm) | 1000 | 1000 | 1000 | 1000 | 1000 | 1000 |
| Permeate-side | Kind | A | A | A | A | A | A |
| channel material | Thickness H0 (mm) | 0.30 | 0.30 | 0.30 | 0.30 | 0.30 | 0.30 |
| | Cross-section area ratio | 0.56 | 0.56 | 0.56 | 0.65 | 0.56 | 0.56 |
| Protrusions of | Plan-view shape | linear (MD) | linear (MD) | linear (MD) | linear (MD) | linear (MD) | linear (MD) |
| permeate-side | Height H1 (mm) | 0.23 | 0.23 | 0.23 | 0.23 | 0.23 | 0.23 |
| channel material | Width W (mm) | 0.37 | 0.37 | 0.37 | 0.37 | 0.37 | 0.37 |
| | Coefficient of variation in channel | 0.03 | 0.03 | 0.03 | 0.03 | 0.03 | 0.03 |
| | width (—) | | | | | | |
| | Length X (mm) | — | — | — | — | — | — |
| Recesses of permeate- | Groove width D (mm) | 0.40 | 0.40 | 0.40 | 0.40 | 0.40 | 0.40 |
| side channel material | Groove length E (mm) | — | — | — | — | — | — |
| Operation conditions | Recovery ratio (%) | 90 | 90 | 90 | 90 | 90 | 90 |
| Performance | Fresh-water production rate (GPD) | 95 | 97 | 97 | 96 | 98 | 96 |
| | Removal ratio (%) | 95.9 | 97.3 | 95.0 | 97.7 | 98.5 | 99.0 |
| | Decrease in fresh-water production rate | 16 | 20 | 21 | 13 | 10 | 12 |
| | (%) | | | | | | |

### Examples 20 and 21

Separation membranes and separation membrane elements were produced in the same manner as in Example 1, except that the sealing plate for preventing raw-water inflow through one end of the separation membrane element was partly opened to change the type of the separation membrane element to the IL type and that the configuration of the separation membrane element was changed to those shown in Table 4.

The separation membrane elements were each loaded in a pressure vessel and evaluated for performances under the same conditions as in Example 1. The results were as shown in Table 4.

### Examples 22 to 24

Separation membranes and separation membrane elements were produced in the same manner as in Example 1, except that the type of the separation membrane element was changed to the inverted-L type and that the configuration of the separation membrane element was changed to those shown in Table 4.

The separation membrane elements were each loaded in a pressure vessel and evaluated for performances under the same conditions as in Example 1. The results were as shown in Table 4.

### Examples 25 to 27

Separation membranes and separation membrane elements were produced in the same manner as in Example 1, except that end plates with holes were used as the first and second end plates to change the type of the separation membrane element to the T type and that the configuration of the separation membrane element was changed to those shown in Table 5.

The separation membrane elements were each loaded in a pressure vessel and evaluated for performances under the same conditions as in Example 1. The results were as shown in Table 5.

TABLE 5

| | | | | | Comparative | Comparative | Comparative |
|---|---|---|---|---|---|---|---|
| | | Example 25 | Example 26 | Example 27 | Example 1 | Example 2 | Example 3 |
| Separation | Type | T type | T type | T type | L type | L type | L type |
| membrane | Element diameter | 2 inches | 2 inches | 2 inches | 2 inches | 2 inches | 2 inches |
| element | Position of raw-water feed part | periphery | periphery | periphery | periphery | periphery | periphery |
| | | side | side | side | side | side | side |
| | Position of concentrate discharge part | end face side | end face side | end face side | end face side | end face side | end face side |
| | Width (mm) | 230 | 230 | 230 | 230 | 230 | 230 |
| | Membrane leaf length (mm) | 1000 | 1000 | 1000 | 1000 | 1000 | 1000 |
| | Membrane leaf length/width (L/W1) | 4.3 | 4.3 | 4.3 | 4.3 | 4.3 | 4.3 |
| | Number of membrane leaves (pieces) | 1 | 1 | 1 | 1 | 1 | 1 |
| | Effective membrane area (m²) | 0.46 | 0.46 | 0.46 | 0.46 | 0.46 | 0.46 |
| Feed-side | Inlet width (mm) | 230 | 230 | 230 | 230 | 230 | 230 |
| channel | Inlet thickness (mm) | 0.5 | 0.5 | 0.5 | 0.5 | 0.5 | 0.5 |
| | Opening ratio (%) | 6 | 23 | 41 | 20 | 20 | 20 |
| | Length (mm) | 1000 | 1000 | 1000 | 1000 | 1000 | 1000 |
| Permeate-side | Kind | A | A | A | A | A | B |
| channel material | Thickness H0 (mm) | 0.30 | 0.30 | 0.30 | 0.30 | 0.30 | 0.30 |
| | Cross-section area ratio | 0.56 | 0.56 | 0.56 | 0.80 | 0.38 | 0.80 |
| Protrusions of | Plan-view shape | linear (MD) | linear (MD) | linear (MD) | linear (MD) | linear (MD) | linear (MD) |
| permeate-side | Height H1 (mm) | 0.23 | 0.23 | 0.23 | 0.23 | 0.23 | 0.23 |
| channel material | Width W (mm) | 0.37 | 0.37 | 0.37 | 0.30 | 0.30 | 0.30 |
| | Coefficient of variation in channel | 0.03 | 0.03 | 0.03 | 0.12 | 0.14 | 0.12 |
| | width (—) | | | | | | |
| | Length X (mm) | — | — | — | — | — | — |
| Recesses of permeate- | Groove width D (mm) | 0.40 | 0.40 | 0.40 | 0.15 | 1.50 | 0.15 |
| side channel material | Groove length E (mm) | — | — | — | — | — | — |
| Operation conditions | Recovery ratio (%) | 90 | 90 | 90 | 90 | 90 | 90 |
| Performance | Fresh-water production rate (GPD) | 97 | 99 | 98 | 90 | 89 | 87 |
| | Removal ratio (%) | 96.8 | 97.6 | 97.3 | 98.2 | 88.0 | 98.0 |
| | Decrease in fresh-water production rate | 14 | 15 | 15 | 16 | 15 | 16 |
| | (%) | | | | | | |

### Comparative Examples 1 to 5

Separation membranes and separation membrane elements were produced in the same manner as in Example 1, except that the permeate-side channel material was replaced with those shown in Tables 5 and 6.

The separation membrane elements were each loaded in a pressure vessel and evaluated for performances under the conditions shown above. The results were as shown in Tables 5 and 6.

That is, in Comparative Examples 1 and 3 to 5, the permeate-side channel materials were dense to increase the permeate-side resistance. In Comparative Example 6, the coefficient of variation in channel width was high, resulting in an increase in flow resistance. These Comparative Examples hence suffered a decrease in fresh-water production rate. Since the rate of feeding raw water and the raw-water flow rate decreased accordingly, a decrease in fresh-water production rate due to scaling occurred.

In Comparative Example 2, since the groove width was large, the separation membrane in the pressure filtration blocked the permeate-side channel and deformed to damage the functional layer of the membrane. Because of this, the fresh-water production rate and the removal ratio decreased.

TABLE 6

| | | Comparative | Comparative | Comparative | Comparative | Comparative | Comparative |
|---|---|---|---|---|---|---|---|
| | | Example 4 | Example 5 | Example 6 | Example 7 | Example 8 | Example 9 |
| Separation | Type | L type | L type | L type | I type | I type | I type |
| membrane | Element diameter | 2 inches | 2 inches | 2 inches | 2 inches | 2 inches | 2 inches |
| element | Position of raw-water feed part | periphery | periphery | periphery | end face | end face | end face |
| | | side | side | side | side | side | side |
| | Position of concentrate discharge part | end face side | end face side | end face side | end face side | end face side | end face side |
| | Width (mm) | 230 | 230 | 230 | 230 | 230 | 230 |
| | Membrane leaf length (mm) | 1000 | 1000 | 1000 | 1000 | 1000 | 1000 |
| | Membrane leaf length/width (L/W1) | 4.3 | 4.3 | 4.3 | 4.3 | 4.3 | 4.3 |
| | Number of membrane leaves (pieces) | 1 | 1 | 1 | 1 | 1 | 1 |
| | Effective membrane area (m²) | 0.46 | 0.46 | 0.46 | 0.46 | 0.46 | 0.46 |
| Feed-side | Inlet width (mm) | 230 | 230 | 230 | 1000 | 1000 | 1000 |
| channel | Inlet thickness (mm) | 0.5 | 0.5 | 0.5 | 0.5 | 0.5 | 0.5 |
| | Opening ratio (%) | 20 | 20 | 20 | 100 | 100 | 100 |
| | Length (mm) | 1000 | 1000 | 1000 | 1000 | 1000 | 1000 |
| Permeate-side | Kind | C | C | D | A | A | A |
| channel material | Thickness H0 (mm) | 0.30 | 0.30 | 0.24 | 0.30 | 0.30 | 0.30 |
| | Cross-section area ratio | 0.80 | 0.80 | 0.90 | 0.65 | 0.65 | 0.65 |
| Protrusions of | Plan-view shape | linear (MD) | linear (MD) | — | linear (MD) | linear (MD) | linear (MD) |
| permeate-side | Height H1 (mm) | 0.23 | 0.23 | — | 0.23 | 0.23 | 0.23 |
| channel material | Width W (mm) | 0.30 | 0.30 | — | 0.37 | 0.37 | 0.37 |
| | Coefficient of variation in channel | 0.12 | 0.12 | 0.12 | 0.03 | 0.03 | 0.03 |
| | width (—) | | | | | | |
| | Length X (mm) | — | — | — | — | — | — |
| Recesses of permeate- | Groove width D (mm) | 0.15 | 0.15 | — | 0.40 | 0.40 | 0.40 |
| side channel material | Groove length E (mm) | — | — | — | — | — | — |
| Operation conditions | Recovery ratio (%) | 90 | 90 | 90 | 90 | 60 | 35 |
| Performance | Fresh-water production rate (GPD) | 91 | 85 | 72 | 92 | 102 | 110 |
| | Removal ratio (%) | 98.0 | 98.0 | 98.0 | 75.8 | 88.0 | 96.6 |
| | Decrease in fresh-water production rate | 16 | 16 | 18 | 31 | 22 | 6 |
| | (%) | | | | | | |

### Comparative Example 7

A separation membrane and a separation membrane element were produced in the same manner as in Example 1 except for the following. The permeate-side channel material was superposed on a permeate-side face of the leaf obtained, and this stack was spirally wound around an ABS (acrylonitrile-butadiene-styrene) water collection tube (width, 350 mm; diameter 18 mm; number of holes, 10 holes×one linear line). A film was further wound around the periphery thereof and fixed with a tape. Thereafter, edge cutting, end plate attachment, and filament winding were performed, thereby producing a separation membrane element having a diameter of 2 inches. The first and second end plates were end plates with holes, and the periphery of the separation membrane element was covered with a commercial PVC tape.

The separation membrane element was loaded in a pressure vessel and evaluated for performances under the conditions shown above. The results were as shown in Table 6.

That is, the raw-water-side channel in this configuration had a wide inlet, resulting in a decrease in raw-water flow rate. This separation membrane element was prone to suffer concentration polarization and tended to have a large decrease in fresh-water production rate.

### Comparative Examples 8 and 9

The same separation membrane element as that produced in Comparative Example 7 was loaded in a pressure vessel and evaluated for performances under the same conditions as in Comparative Example 6, except that the recovery ratio was changed to 60% in Comparative Example 8 and 35% in Comparative Example 9. The results were as shown in Table 6.

### Comparative Examples 10 to 12

Separation membranes and separation membrane elements were produced in the same manner as in Example 1, except that the width of the separation membrane element, the membrane leaf length, and the number of membrane leaves were changed as shown in Table 7.

The separation membrane elements were each loaded in a pressure vessel and evaluated for performances under the same conditions as in Example 1. The results were as shown in Table 7.

That is, these separation membrane elements each had a shortened permeate-side channel because of the small membrane leaf length. Although a permeate-side channel material according to the present invention was used therein, the reduction in permeate-side resistance was little. In addition, since the membrane width was large and the raw-water feed part was large, the raw-water flow rate was low. Because of these, the membrane-face concentration increased to result in a decrease in removal ratio, and scaling occurred to result in a larger decrease in fresh-water production rate.

TABLE 7

| | | Comparative | Comparative | Comparative |
|---|---|---|---|---|
| | | Example 10 | Example 11 | Example 12 |
| Separation | Type | L type | L type | L type |
| membrane | Element diameter | 2 inches | 2 inches | 2 inches |
| element | Position of raw-water feed part | periphery | periphery | periphery |
| | | side | side | side |
| | Position of concentrate discharge part | end face side | end face side | end face side |
| | Width (mm) | 550 | 1000 | 230 |
| | Membrane leaf length (mm) | 420 | 230 | 500 |
| | Membrane leaf length/width (L/W1) | 0.8 | 0.2 | 2.2 |
| | Number of membrane leaves (pieces) | 1 | 1 | 2 |
| | Effective membrane area (m²) | 0.46 | 0.46 | 0.46 |
| Feed-side | Inlet width (mm) | 230 | 1000 | 1000 |
| channel | Inlet thickness (mm) | 0.5 | 0.5 | 0.5 |
| | Opening ratio (%) | 20 | 20 | 20 |
| | Length (mm) | 420 | 230 | 230 |
| Permeate-side | Kind | A | A | A |
| channel material | Thickness H0 (mm) | 0.30 | 0.30 | 0.30 |
| | Cross-section area ratio | 0.65 | 0.65 | 0.65 |
| Protrusions of | Plan-view shape | linear (MD) | linear (MD) | linear (MD) |
| permeate-side | Height H1 (mm) | 0.23 | 0.23 | 0.23 |
| channel material | Width W (mm) | 0.37 | 0.37 | 0.37 |
| | Coefficient of variation in channel width (—) | 0.03 | 0.03 | 0.03 |
| | Length X (mm) | — | — | — |
| Recesses of permeate- | Groove width D (mm) | — | 0.40 | 0.40 |
| side channel material | Groove length E (mm) | — | — | — |
| Operation conditions | Recovery ratio (%) | 90 | 90 | 90 |
| Performance | Fresh-water production rate (GPD) | 111 | 115 | 103 |
| | Removal ratio (%) | 95.0 | 93.2 | 96.0 |
| | Decrease in fresh-water | 35 | 40 | 26 |
| | production rate (%) | | | |

As apparent from the results shown in Tables 1 to 7, the separation membrane elements of Examples 1 to 27 according to the present invention, even when operated at a high pressure, can have high removal performance to provide a sufficient amount of permeate. These separation membrane elements stably have excellent separation performance.

### DESCRIPTION OF REFERENCE NUMERALS AND SIGNS

1 Raw-water-side channel material
101 Raw water
101A Raw-water feed part
102 Permeate
103 Concentrate
103B Concentrate discharge part
2 Separation membrane
3 Permeate-side channel material
4 Water collection tube
5 General separation membrane element (I-type element)
5B L-type element
5C Inverted-L-type element
5D IL-type element
5E T-type element
6 Protrusion
7 Recess
821 Holes formed in porous member
91 End plate without holes
92 End plate with holes
D Groove width
E Groove length
H0 Thickness of permeate-side channel material
H1 Height of protrusion of permeate-side channel material
H2 Thickness of raw-water-side channel material
L Length of separation membrane leaf (length of raw-water-side channel)
OL Opening length
S Cross-sectional area of protrusion of permeate-side channel material
V_{F} Raw-water flow rate per unit time
V_{P} Permeate flow rate per unit time
W Width of protrusion of permeate-side channel material
W1 Width of separation membrane leaf
X Length of protrusion of permeate-side channel material

1. A separation membrane element comprising:
a plurality of separation membranes each having a raw-water-side face and a permeate-side face and forming a separation membrane leaf by being arranged so that the raw-water-side faces face each other;
a permeate-side channel material provided between the permeate-side faces of the separation membranes to form a permeate-side channel;
a raw-water-side channel material provided between the raw-water-side faces of the separation membranes to form a raw-water-side channel; and
a water collection tube for collecting a permeate,
wherein the separation membrane leaf has openings respectively in a peripheral part in a direction perpendicular to a longitudinal direction of the water collection tube, and in an end face in the longitudinal direction of the water collection tube, and
the separation membrane leaf has a width W1 of 150 mm to 400 mm,
the permeate-side channel material has a coefficient of variation in channel width of 0.00-0.10, and the separation membrane leaf has a ratio between the width W1 and a length L of the separation membrane leaf, L/W1, of 2.5 or larger.

2. The separation membrane element according to claim 1, wherein the length L of the separation membrane leaf is 750 mm to 2,000 mm.

3. The separation membrane element according to claim 1, which comprises:
a raw-water feed part which is the opening formed in the peripheral part of the separation membrane leaf in the direction perpendicular to the longitudinal direction of the water collection tube; and
a concentrate discharge part which is the opening formed in a one-side end face of the separation membrane leaf in the longitudinal direction of the water collection tube,
the concentrate discharge part being an opening formed by opening a part of the one-side end face.

4. The separation membrane element according to claim 3, wherein the concentrate discharge part has a length which is 5-35% of the length L of the separation membrane leaf.

5. The separation membrane element according to claim 3, wherein the concentrate discharge part has a length which is 15-25% of the length L of the separation membrane leaf.

6. The separation membrane element according to claim 1, which comprises:
a raw-water feed part which is the opening formed in a one-side end face of the separation membrane leaf in the longitudinal direction of the water collection tube; and
a concentrate discharge part which is the opening formed in the peripheral part of the separation membrane leaf in the direction perpendicular to the longitudinal direction of the water collection tube,
the concentrate discharge part being an opening formed by opening a part of the peripheral part.

7. The separation membrane element according to claim 6, wherein the raw-water feed part has a length which is 10-40% of the length L of the separation membrane leaf.

8. The separation membrane element according to claim 6, wherein the raw-water feed part has a length which is 15-20% of the length L of the separation membrane leaf.

9. The separation membrane element according to claim 1, which comprises:
raw-water feed parts which are the openings formed in both end faces of the separation membrane leaf in the longitudinal direction of the water collection tube; and
a concentrate discharge part formed in the peripheral part of the separation membrane leaf in the direction perpendicular to the longitudinal direction of the water collection tube,
the raw-water feed parts being openings formed by opening a part of each of the both end faces.

10. The separation membrane element according to claim 9, wherein the raw-water feed parts have a length which is 5-45% of the length L of the separation membrane leaf.

11. The separation membrane element according to claim 9, wherein the raw-water feed parts have a length which is 15-30% of the length L of the separation membrane leaf.

12. The separation membrane element according to claim 1, wherein the opening of the end face in the longitudinal direction of the water collection tube is formed as a single opening extending from an inner end of the separation membrane leaf toward an outside along the direction perpendicular to the longitudinal direction of the water collection tube.

13. A method for operating the separation membrane element according to claim 1, wherein water is fed to the separation membrane element to produce fresh water in an amount which is 35% or more of the water fed to the separation membrane element.

14. A separation membrane element comprising:
a plurality of separation membranes each having a raw-water-side face and a permeate-side face and forming a separation membrane leaf by being arranged so that the raw-water-side faces face each other;
a permeate-side channel material provided between the permeate-side faces of the separation membranes to form a permeate-side channel; and
a water collection tube for collecting a permeate,
wherein the permeate-side channel material has a cross-section along a longitudinal direction of the water collection tube, the cross-section having a plurality of channels and having a cross-section area ratio of 0.4-0.75, and
the separation membrane leaf comprises: a raw-water feed part which is an opening formed in a peripheral part of the separation membrane leaf in a direction perpendicular to the longitudinal direction of the water collection tube; and
a concentrate discharge part which is an opening formed in an end-face side portion in the longitudinal direction of the water collection tube.
